(19) United States
(12) Patent Application Publication
(10) Pub. No.: US 2011/0229219 A1
(43) Pub. Date: Sep. 22, 2011

(54) IMAGE FORMING APPARATUS

(75) Inventors: Nobuyuki KOBAYASHI, Kanagawa (JP); Shigeyuki Ishii, Tokyo (JP); Jun Kosako, Kanagawa (JP); Miyo Taniguchi, Kanagawa (JP); Takahiro Miyakawa, Kanagawa (JP); Takashi Enami, Kanagawa (JP); Natsuko Kawase, Kanagawa (JP); Takahiro Kamekura, Kanagawa (JP)

(73) Assignee: RICOH COMPANY, LTD., Tokyo (JP)

(21) Appl. No.: 13/046,997

(22) Filed: Mar. 14, 2011

(30) Foreign Application Priority Data
Mar. 18, 2010 (JP) 2010-062737

(51) Int. Cl. G03G 15/01

(52) U.S. Cl. 399/301

(57) ABSTRACT

An image forming apparatus includes a direct transfer part moving color adjustment patterns of a single color formed on a photosensitive drum to a direct transfer member; a secondary transfer part that moves the color adjustment patterns of the single color moved to the direct transfer member to an intermediate transfer member; a primary transfer part that moves color adjustment patterns of plural colors formed on plural photopositive drums to the intermediate transfer member; a detection part that detects the color adjustment patterns of the single color moved to the intermediate transfer member and the color adjustment patterns of the plural colors moved to the intermediate transfer member; and a color adjustment part that carries out the color adjustment of the respective printing images based on information of the color adjustment patterns of the single color and the plural colors detected by the detection part.

### BACKGROUND OF THE INVENTION

1. Field of the Invention

The present invention relates to an art of correcting a color registration error in an image forming apparatus.

2. Description of the Related Art

There is an image forming apparatus of tandem type in which photosensitive drums and developing apparatuses are provided for respective colors of yellow, magenta, cyan and black (simply referred to as Y, M, C and K, respectively, hereinafter), a single-color toner image for printing images is formed on each of the respective photosensitive drums, the respective single-color toner images are transferred in sequence and a color image is formed on transfer paper.

In the image forming apparatus of tandem type, in a case where a slight change occurs in a moving speed of an intermediate transfer belt, an error may occur in transfer positions for the respective colors because reaching times for transfer positions for subsequent colors change, and a color registration error (position error) may occur in a sub-scan direction (i.e., a direction in which the intermediate transfer belt moves) in the output printing image.

Further, because writing units are independent for the respective colors, a color registration error may occur in a main scan direction (a direction of the axes of the photosensitive drums) in the output printing image in a case where a magnification and/or a writing position in the main scan direction change as a position of a part/component of the writing units shifts because of a change of an environment factor such as temperature.

Further, a color registration error that may occur in plural single-color toner images transferred to the intermediate transfer belt in a superposing manner may occur because of a phase difference between the photosensitive drums of the respective colors.

Therefore, for the image forming apparatus of tandem type, a method is known in which color adjustment patterns are formed on the intermediate transfer belt between an image processing area for a preceding page and an image processing area for a subsequent page, the color adjustment patterns are read by sensors of photo-interrupter type, a color registration error in the main scan direction and the sub-scan direction is thus detected, and the color registration error is corrected (for example, see Patent Document No. 1, i.e., Japanese Laid-Open Patent Application NO. 2006-113150). Generally speaking, the number of the sensors to be provided is such that a total of two sensors may be provided one at the left end and one at the right end in a width direction of the intermediate transfer belt, or, depending on a lateral width of the intermediate transfer belt, one more sensor is provided at the center and thus a total of three sensors may be provided.

Further, a configuration of the image forming apparatus is known in which an indirect transfer system is used for the colors Y, M and C, and a direct transfer system is used for the color K (for example, see Patent Document No. 2, i.e., Japanese Laid-Open Patent Application No. 2001-175091).

In a case of the image forming apparatus having the configuration as discussed in Patent Document No. 2 in which the indirect transfer system is used for the colors Y, M and C and the direct transfer system is used for the color K, a method may be considered in which color adjustment patterns are formed on respective belts (i.e., on an immediate transfer belt for the indirect transfer system and a transfer paper conveyance belt for the direct transfer system), the respective pattern images are read by sensors that are provided for the respective belts, and a color registration error is detected.

However, in this method, a number of the sensors which are double those in the configuration discussed in Patent Document No. 2 are required. That is, in the case where a total of two sensors are provided in the configuration of Patent Document No. 2, a total of four sensors are required. Similarly, in the case where a total of three sensors are provided in the configuration of Patent Document No. 2, a total of six sensors are required.

As a result, the costs may increase not only due to extra costs for the additional sensors themselves but also for installing wirings and guide members to block light appropriately, extra costs for assembling the sensors because the sensors are to be installed with high accuracy, and so forth. Further, the size of the image forming apparatus may increase accordingly because an increased number of sensors are installed.

### SUMMARY OF THE INVENTION

In an embodiment of the present invention, an image forming apparatus includes a direct transfer part that moves color adjustment patterns of a single color having been formed on a photosensitive drum and that is used for color adjustment of respective printing images to a direct transfer member; a secondary transfer part that moves the color adjustment patterns of the single color having been moved to the direct transfer member by the direct transfer part to an intermediate transfer member; a primary transfer part that moves color adjustment patterns of plural colors having been formed on plural photopositive drums and that is used for the color adjustment of the respective printing images to the intermediate transfer member; a detection part that detects the color adjustment patterns of the single color having been moved to the intermediate transfer member by the secondary transfer member and the color adjustment patterns of the plural colors having been moved to the intermediate transfer member by the primary transfer member; and a color adjustment part that carries out the color adjustment of the respective printing images based on information of the color adjustment patterns of the single color and the color adjustment patterns of the plural colors detected by the detection part.

Other objects, features and advantages of the present invention will become more apparent from the following detailed description when read in conjunction with the accompanying drawings.

### BRIEF DESCRIPTION OF THE DRAWINGS

FIG. 1 shows a general configuration of a color digital multifunction peripheral according to an embodiment of the present invention;

FIG. 2 generally shows a configuration of a secondary transfer mechanism according to the embodiment of the present invention;

FIG. 3 shows a block diagram of a hardware configuration of the color digital multifunction peripheral according to the embodiment of the present invention;

FIG. 4 shows a block diagram of a hardware configuration of a printer part according to the embodiment of the present invention;

FIG. 5 shows a block diagram of a functional configuration of the printer part according to the embodiment;

FIG. 6 illustrates a state of detecting patterns by a pattern detection sensor according to the embodiment of the present invention;

FIG. 7 shows a plan view of one example of position adjustment patterns 13Y, 13M and 13C according to the embodiment of the present invention;

FIG. 8 shows a plan view of one example of position adjustment patterns 13K according to the embodiment of the present invention;

FIG. 9 shows combination patterns according to the embodiment of the present invention;

FIG. 10 shows a flowchart illustrating operations of carrying out positional error detection by using the position adjustment patterns according to the embodiment of the present invention;

FIG. 11 shows combination patterns according to the embodiment of the present invention; and

FIG. 12 shows a flowchart illustrating operations of carrying out detection of phases of photosensitive drums by using phase detection patterns according to the embodiment of the present invention;

### DETAILED DESCRIPTION OF THE EMBODIMENTS

An embodiment of the present invention has been devised for solving the above-mentioned problems, and an object of the embodiment is to make it possible, in an image forming apparatus having a configuration such that the indirect transfer system is used for the colors Y, M and C and the direct transfer system is used for the color K, that a color registration error is corrected without increasing the number of the sensors.

According to the embodiment, because it is possible, in the image forming apparatus having the configuration such that the indirect transfer system is used for the colors Y, M and C and the direct transfer system is used for the color K, that a color registration error is corrected without increasing the number of the sensors, it is possible to avoid an increase in the costs and the size of the image forming apparatus.

Below, the embodiment of the present invention will be described in detail with reference to figures. The embodiment is an example in which a color digital multifunction peripheral is used and, in the color digital multifunction peripheral, a copy function, a facsimile (FAX) function, a printer function, a scanner function, a function of delivering an input image (i.e., an original image having been read by a scanner function, or an image having been input by a print function or a facsimile function) and so forth are combined.

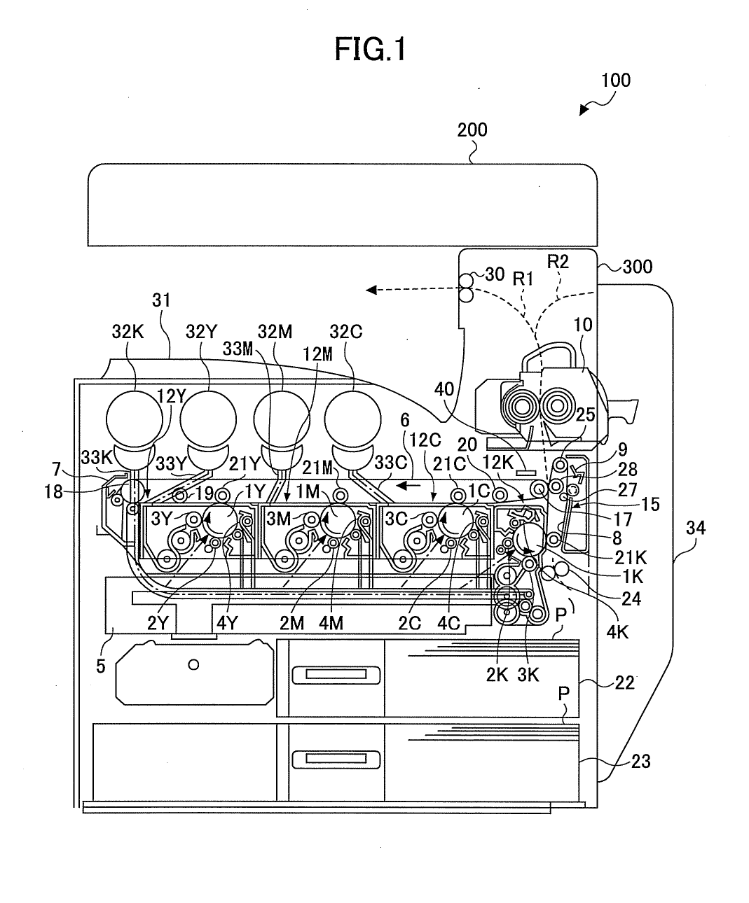

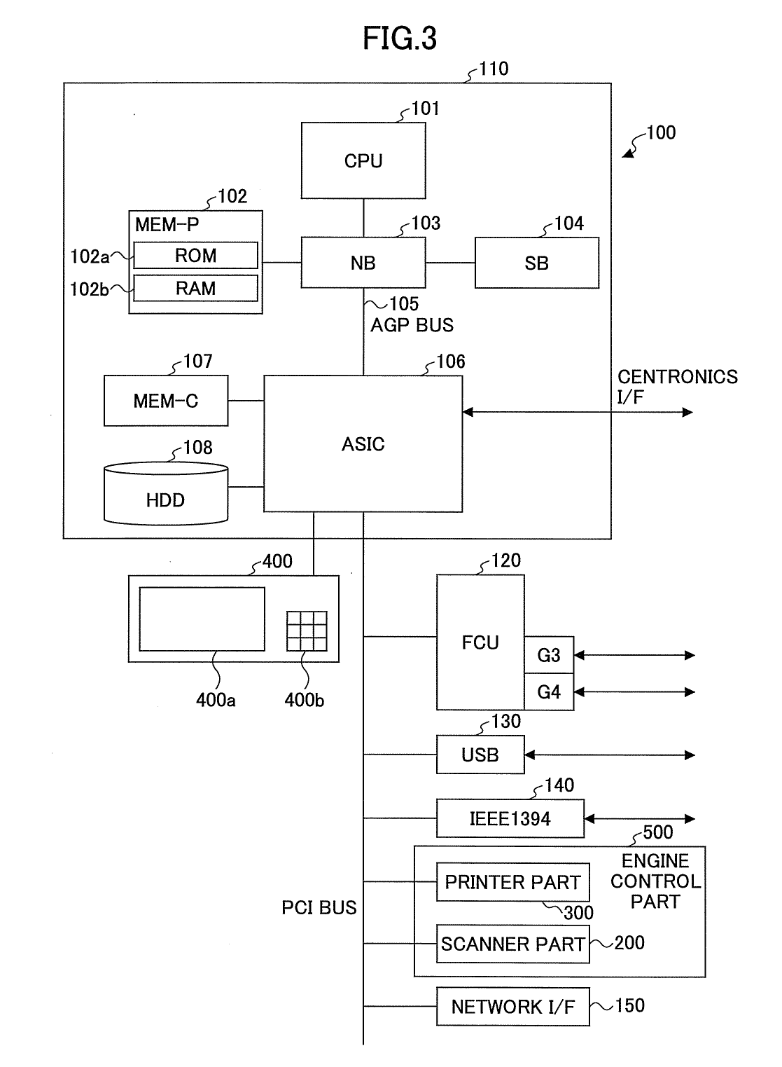

FIG. 1 shows a general configuration of the color digital multifunction peripheral 100 according to the embodiment of the present invention. As shown in FIG. 1, the color digital multifunction peripheral 100 includes a scanner part 200 acting as an image reading apparatus, and a printer part 300 acting as an image printing apparatus of electrophotographic type. The scanner part 300 and the printer part 200 are included in an engine control part 500 (see FIG. 3). In the color digital multifunction peripheral 100 according to the embodiment, it is possible for a user to select any one of a document box function, a copy function, a printer function and a facsimile function by switching them in sequence with an application switching key on an operation part 400 (see FIG. 3). A document box mode is entered when the document box function has been selected; a copy mode is entered when the copy function has been selected; a printer mode is entered when the printer function has been selected; and a facsimile mode entered when the facsimile function has been selected.

The printer part 300 in the color digital multifunction puerperal 100 according to the embodiment will now be described. The printer part 300 in the color digital multifunction peripheral 100 is one of tandem type such that as shown in FIG. 1; three image forming units 12Y, 12M and 12C for the three colors Y, M and C are disposed in series in a moving direction of an intermediate transfer belt 6, along the intermediate transfer belt 6 acting as an intermediate transfer member which has a loop shape and extends approximately horizontally. The intermediate transfer belt 6 is supported by a driving roller 17, a driven roller 18 and tension rollers 19 and 20. A cleaning part 7 is provided in the outside of the intermediate transfer belt 6 and facing the driven roller 18 for removing residual toner from the intermediate transfer belt 6.

In addition, in the printer part 300 of the color digital multifunction peripheral 100, an image forming unit 12K for the color K is provided, independent from the above-mentioned tandem arrangement of the image forming units 12Y, 12M and 12C, in an upstream position with respect to the tandem arrangement, in a direction in which transfer paper (recording paper) moves. The image forming unit 12K of the color K is disposed so that a toner image of the color K of the image forming unit 12K is directly transferred to the transfer paper. In more detail, the image forming unit 12K of the color K is independent from a configuration of transferring toner images of the colors Y, M and C to the intermediate transfer belt 6, and the K-color toner image created in the image forming unit 12K is directly transferred to the transfer paper by means of a secondary transfer mechanism 15 that is different from the intermediate transfer belt 6. The secondary transfer mechanism 15 is disposed to cross, approximately perpendicularly, the intermediate toner belt 6 that extends approximately horizontally. The secondary transfer mechanism 15 is disposed at a position on a path in which the transfer paper P is conveyed, on which transfer paper P printing images of the plural colors mutually superposed on the intermediate transfer belt 6 and a printing image of the color K transferred to the transfer paper P are superposed on each other. In more detail, the image forming unit 12K of the color K is disposed near and along an approximately vertical conveyance path of the transfer paper P, and the secondary transfer mechanism 15 is disposed by using a space on an upstream side of a fixing apparatus 10 in the approximately vertical conveyance path.

The respective image forming units 12Y, 12M, 12C and 12K are configured in a form of process cartridges that are detachable from the body of the printer part 300. The respective image forming units 12Y, 12M, 12C and 12K have photosensitive drums 1 (i.e., 1Y, 1M, 1C and 1K), electrification units 2 (i.e., 2Y, 2M, 2C and 2K), development units 3 (i.e., 3Y, 3M, 3C and 3K) which supply toners to latent images and form toner images, cleaning apparatuses 4 (i.e., 4Y, 4M, 4C and 4K) and so forth. In the respective image forming units 12Y, 12M and 12C, the respective photosensitive drums 1Y, 1M and 1C are disposed to come into contact with a lower extended surface of the intermediate transfer belt 6. Further, in the inside of the intermediate transfer belt 6, primary transfer rollers 21Y, 21M and 21C as primary transfer parts are provided to face the respective photosensitive drums 1Y, 1M and 1C.

Further, the printer part 300 of the color digital multifunction peripheral 100 includes an exposure apparatus 5, corresponding to the image forming units 12Y, 12M, 12C and 12K of the respective colors, which exposure apparatus 5 emits laser light beams from LDs (not shown). An original image read by the scanner part 20, data received via facsimile or such, or color image information sent from a computer or such, is decomposed into the respective colors Y, M, C and K, data of separations of the respective colors are formed, and are sent to the exposure apparatus 5. The laser light beams for the respective colors emitted by the LDs of the exposure apparatus 5 form electrostatic latent images on the respective photosensitive drums 1Y, 1M, 1C and 1K of the respective image forming units 12Y, 12M, 12C and 12K.

It is noted that according to the embodiment, as the cleaning apparatuses 4 and 9, those of blade type are used. However, embodiments of the present invention are not so limited, and those of fur brush roller type, magnetic brush cleaning type or such may also be used. Further, the exposure apparatus 5 is not limited to that of laser type, and that of LED (Light Emitting Diode) type or such may also be used.

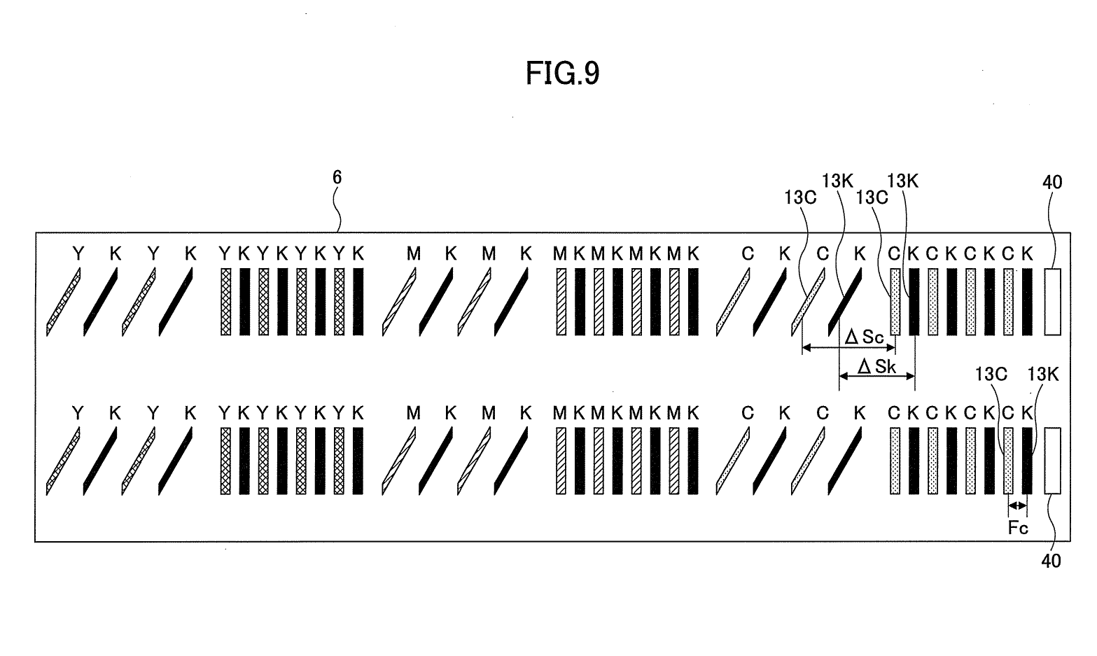

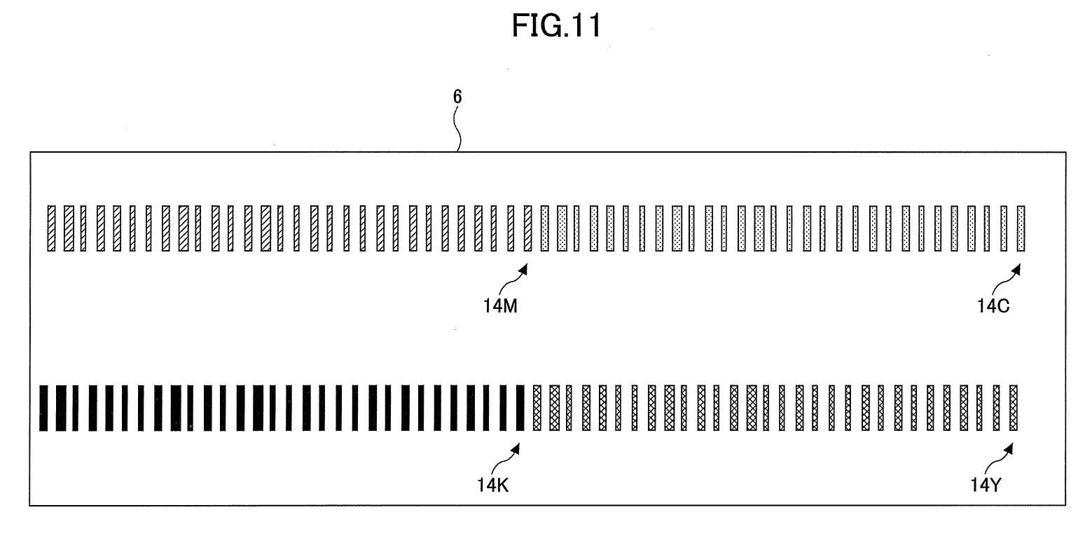

In the printer part 300, pattern detection sensors 40 that detect position adjustment patterns (i.e., 13Y, 13M, 13C and 13K (see FIG. 9)) as color adjustment patterns and phase detection patterns 14 (i.e., 14Y, 14M, 14C and 14K (see FIG. 11)) as color adjustment patterns formed on the intermediate transfer belt 6 are provided at the left end and the right end in a width direction of the intermediate transfer belt 6 for detecting skew amounts occurring in scanning operations of the LDs (not shown). Depending on the lateral width of the intermediate transfer belt 6, one sensor may be added at the center of the intermediate transfer belt 6 and thus, a total of three pattern detection sensors 40 may be provided.

In a case where optical sensors of reflection type (regular reflection sensors) are used as the pattern detection sensors 40, the pattern detection sensors 40 emit light to the intermediate transfer belt 6, detect reflected light from the position adjustment patterns 13 and the phase detection patterns 14 formed on the intermediate transfer belt 6 and the intermediate transfer belt 6, and thus obtain information to be used for measuring a color registration error amount.

It is noted that although the regular reflection sensors are used as the pattern detection sensors 40 as mentioned above, the reflection sensors are not limited to this type, and diffuse reflection sensors that read light diffused by the position adjustment patterns 13, the phase detection patterns 14 and the intermediate transfer belt 6 may be used.

As a color adjustment function using the position adjustment patterns 13 and the phase detection patterns 14, a skew with respect to a reference color, a sub-scan registration error, a main scan registration error and a main scan magnification error can be measured. It is noted that actual reading is carried out in such a manner that edge parts of the position adjustment patterns 13 and the phase detection patterns 14 are read.

Under the printer part 300 in the color digital multifunction puerperal 100, paper feeding trays 22 and 23 of different transfer paper sizes are provided, transfer paper P fed from the paper feeding tray 22 or tray 23 by means of a paper feeding part (not shown) is conveyed by a conveyance part (not shown). Thus, the transfer paper P reaches a registration roller pair 24, a skew is corrected here, and after that, the transfer paper P is conveyed by the registration roller pair 24 at a predetermined timing to a position at which transfer is carried out from the photosensitive drum 1K to a transfer paper conveyance belt 8.

Further, the printer part 300 of the color digital multifunction peripheral 100 includes a toner bank 32 above the intermediate transfer belt 6. The toner bank 32 includes toner tanks 32K, 32Y, 32C and 32M. These toner tanks 32K, 32Y, 32C and 32M are connected to the respective development apparatuses 3 (3Y, 3M, 3C and 3K) by means of toner supply pipes 33K, 33Y, 33C and 33M. The image forming unit 12K of the color K is disposed independent from the image forming units 12Y, 12M and 12C of the colors Y, M and C, and therefore, transfer toners of the colors Y, M and C are prevented from mixing into an image forming process of the color K. Therefore, toner collected from the photosensitive drum 1K is reused after being conveyed to the development apparatus 3K via a toner collection path (not shown). It is noted that on the way of the toner collection path, an apparatus for removing paper powder and an apparatus that makes it possible to switch to a path for discarding the toner may be provided.

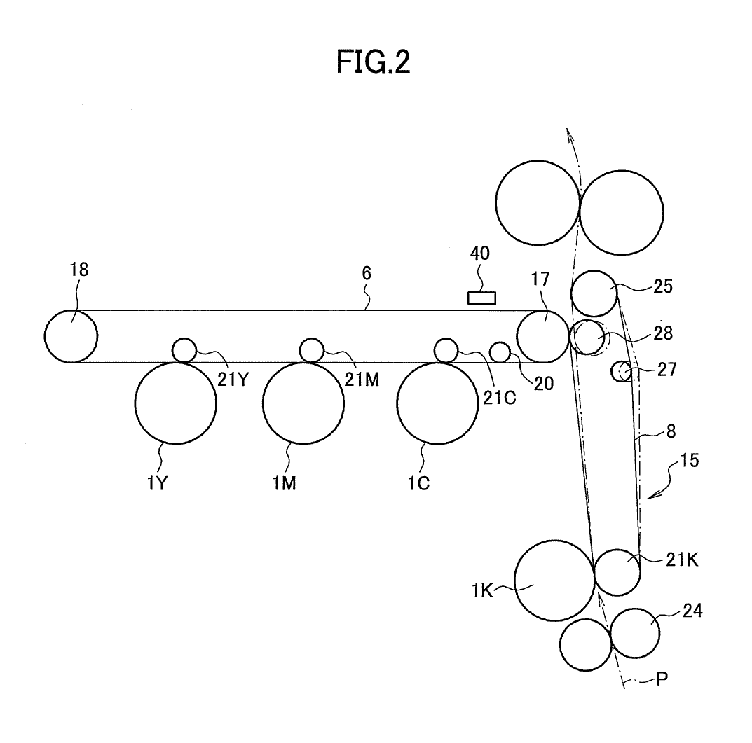

FIG. 2 is a schematic diagram that generally shows a configuration of the secondary transfer mechanism 15. As shown in FIG. 2, the secondary transfer mechanism 15 includes the transfer paper conveyance belt 8 as a direct transfer member, a driving roller 25 that supports the transfer paper conveyance belt 8, a driven roller 21K also acting as a direct transfer part, a tension roller 27, a secondary transfer roller 28 as a secondary transfer part, and a cleaning apparatus 9 (see FIG. 1) that cleans the surface of the transfer paper conveyance belt 8. The secondary transfer roller 28 is disposed to face, via the transfer paper conveyance belt 8 and the intermediate transfer belt 6, the driving roller 17 of the intermediate transfer belt 6. The secondary transfer roller 28 may be configured to be able to come into contact with, via the transfer paper conveyance belt 8 as shown by a solid line in FIG. 2, and to separate from, as shown by an alternate long and short dash line in FIG. 2, the intermediate transfer belt 6 by mean of a contact/separate mechanism (not shown), as a result of the tension roller 27 maintaining tension of the transfer paper conveyance belt 8. Further, the intermediate transfer belt 6 may come into contact with and separate from the transfer paper conveyance belt 8 as a result of the driving roller 17 that supports the intermediate transfer belt 6 being moved by a contact/separated mechanism (not shown) and the tension of the intermediate transfer belt 6 being maintained by the tension roller 20.

At a time of printing, a printing image in a form of a latent image on the photosensitive drum 1K is directly transferred onto the transfer paper P, and printing images in a form of latent images on the photosensitive drums 1Y, 1M and 1C are superposed on each other on the intermediate transfer belt 6. Then, a transfer voltage is applied by an applying part (not shown) to the secondary transfer roller 28. Thereby, the printing images of the colors Y, M and C are transferred onto the transfer paper P to be superposed on the printing image of the color K, and printing is thus carried out.

In a case where detection of a position error is carried out, position adjustment patterns 13K as color adjustment patterns in a form of latent images on the photosensitive drum 1K are moved onto the transfer paper conveyance belt 8, and position adjustment patterns 13Y, 13M and 13C in a form of latent images on the photosensitive drums 1Y, 1M and 1C are moved onto the intermediate transfer belt 6. Then, a voltage reverse to the transfer voltage applied at the time of printing is applied to the secondary transfer roller 28 by an applying part (not shown). Thereby, the position adjustment patterns 13K having been thus moved onto the transfer paper conveyance belt 8 are moved onto the intermediate transfer belt 6. Thereby, the position adjustment patterns 13 of all the colors Y, M, C and K are formed on the intermediate transfer belt 6. Then, by reading by the pattern detection sensors 40 these position adjustment patterns 13, detection of a position error is carried out.

In a case where detection of phases of the photosensitive drums is carried out, phase detection patterns 14K as color adjustment patterns in a form of latent images on the photosensitive drum 1K are moved onto the transfer paper conveyance belt 8, and phase detection patterns 14Y, 14M and 14C in a form of latent images on the photosensitive drums 1Y, 1M and 1C are moved onto the intermediate transfer belt 6. Then, a voltage reverse to the transfer voltage applied at the time of printing is applied to the secondary transfer roller 28 by the applying part (not shown). Thereby, the phase detection patterns 14K having been thus moved onto the transfer paper conveyance belt 8 are moved onto the intermediate transfer belt 6. Thereby, the phase detection patterns 14 of all the colors Y, M, C and K are formed on the intermediate transfer belt 6. Then, by reading by the pattern detection sensors 40 these phase detection patterns 14, detection of phases of the photosensitive drums is carried out.

FIG. 3 shows a block diagram of a hardware configuration of the color digital multifunction peripheral 100. As shown in FIG. 3, the color digital multifunction peripheral 100 is configured such that a controller 110, the printer part 300 and the scanner part 200 are connected by a PCI (Peripheral Component Interconnect) bus. The controller 110 carries out control of the entirety of the color digital multifunction peripheral 100, image drawing control, communication control, and control of input from the operation part 400. It is noted that the printer part 300 or the scanner part 200 includes an image processing part that carries out an error diffusion process, a gamma conversion process and so forth. The operation part 400 includes an operation display part 400a that displays on a LCD (Liquid Crystal Display) original image information of an original image read by the scanner part 200 and so forth, and also, receives key input from an operator via a touch panel. The operation part 400 further includes a keyboard part 400b that receives key inputs from the operator.

The controller 110 includes a CPU (Central Processing Unit) 101 that is a main part of a computer, a system memory (MEM-P) 102, a north bridge (NB) 103, a south bridge (SB) 104, an ASIC (Application Specific Intergraded Circuit) 106, a local memory (MEM-C) 107 as a storage part and a hard disk drive (HDD) 108 also as a storage part. In the controller 110, an AGP (Accelerated Graphics Port) bus 105 connects the NB 103 and the ASIC 106 together. Further, the MEM-P 102 includes a ROM (Read Only Memory) 102a and a RAM (Random Access Memory) 102b.

The CPU 101 carries out control of the entirety of the color digital multifunction peripheral 100, has a chip set including the NB 103, the MEM-P 102 and the SB 104, and is connected with other apparatuses via the chip set.

The NB 103 is a bridge that connects the CPU 101 with the MEM-P 102, the SB 104, and the AGP bus 105, and has a memory controller (not shown) which controls reading from and writing to the MEM-P 102, a PCI master (not shown) and an AGP target (not shown).

The MEM-P 102 is a system memory that is used as a memory for storing programs and data, a memory for expanding the programs or data and a memory for drawing an image for the printer part 300, and includes the ROM 102a and the RAM 102b. The ROM 102a is a read only memory that stores the programs and data for controlling operations of the CPU 101. The RAM 102b is a memory, to be used for expanding the programs and data, to which writing can be carried out and from which reading can be carried out.

The SB 104 is a bridge for connecting the NB 103 with PCI devices and peripheral devices. The SB 104 is connected with the NB 103 via the PCI bus. To the PCI bus, a network interface (I/F) 150 and so forth are connected.

The ASIC 106 is an IC (Integrated Circuit) to be used for image processing which includes hardware elements for image processing. The ASIC 106 acts as a bridge to connect the AGP bus 105, the PCI bus, the HDD 108 and the MEM-C 107. The ASIC 106 includes a PCI target and an AGP master, an arbiter (ARB) that plays a central role of the ASIC 106, a memory controller that controls the MEM-C 107, plural DMACs (Direct Memory Access Controllers) that carry out rotation of an image by means of a hardware logic, and a PCI unit that carries out data transfer by using the PCI bus with the printer part 300 and the scanner part 200. To the ASIC 106, an FCU (Fax Control Unit) 120, a USB (Universal Serial Bus) 130 and an IEEE 1394 (the Institute of Electrical and Electronics Engineers 1394) interface 140 are connected via the PCI bus.

The MEM-C 107 is the local memory to be used as a buffer for storing an image to be copied or a buffer for storing code. The HDD 108 is a storage for storing image data, storing programs that control operations of the CPU 101, storing font data and storing forms.

The AGP bus 105 is a bus interface for a graphics accelerator card that has been proposed to accelerate graphics processing. The AGP bus 105 accelerates operations of the graphics accelerator card by directly accessing the MEM-P 102 with high throughput.

It is noted that the programs that are executed in the color digital multifunction peripheral 100 according to the present embodiment are provided in such a manner that the programs have been previously stored in the ROM 102a or such. The programs executed in the color digital multifunction peripheral 100 according to the present embodiment may be provided in a form of files of installable type or executable type, and provided as having been stored in a computer readable recording medium such as a CD-ROM (Compact Disc Read Only Memory), a flexible disk (FD), a CD-R (Compact Disc Recordable), a DVD (Digital Versatile Disc) or such.

Further, the programs executed in the color digital multifunction peripheral 100 according to the present embodiment may be stored in a computer that is connected with the color digital multifunction peripheral 100 via a network such as the Internet, and provided as a result of the programs being downloaded from the computer via the network. Further, the programs executed in the color digital multifunction peripheral 100 according to the present embodiment may be provided or delivered via a network such as the Internet.

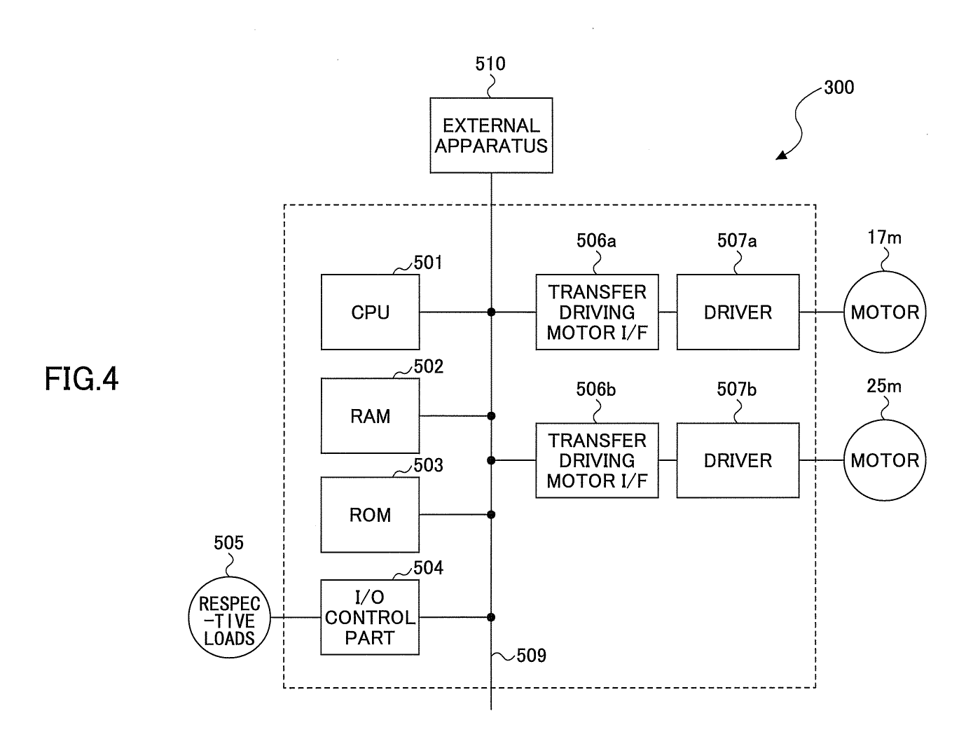

FIG. 4 shows a block diagram of a hardware configuration of the printer part 300. As shown in FIG. 4, a control system of the printer part 300 includes a CPU 501, a RAM 502, a ROM 503, a I/O control part 504, a transfer driving motor I/F part 506a, a driver 507a, a transfer driving motor I/F part 506b and a driver 507b.

The CPU 501 controls the entirety of the printer part 300 of the color digital multifunction peripheral 100. For example, the CPU 501 controls reception of image data that is input from external apparatuses 510 such as the controller 110, the FCU 120, the USB 130, the IEEE 1394 interface 140, the network I/F 150 and so forth (see FIG. 3), and controls transmission and reception of command data with the external apparatuses 510.

The RAM 502 to be used as a work area of the CPU 501, the ROM 503 that stores programs and the I/O control part 504 are connected mutually via a bus 509. According to instructions given by the CPU 501, data is written to and read from the RAM 502; instructions are read from the ROM 503; and operations of various parts such as motors that drive respective loads 505, clutches, solenoids, sensors and so forth, and detection of a color registration error are carried out via the I/O control part 504.

The transfer driving motor I/F 506a outputs an instruction signal that indicates a driving frequency of a driving pulse signal to the driver 507a according to a driving instruction from the CPU 501. According to the driving frequency, a driving motor 17m is driven and rotated. As a result, the driving roller 17 shown in FIG. 2 is driven and rotated. Similarly, the transfer driving motor I/F 506b outputs an instruction signal that indicates a driving frequency of a driving pulse signal to the driver 507b according to a driving instruction from the CPU 501. According to the driving frequency, a driving motor 25m is driven and rotated. As a result, the driving roller 25 shown in FIG. 2 is driven and rotated.

Further, the RAM 502 is used as the work area of the CPU 501 when the CPU 501 executes the programs stored in the ROM 503. The RAM 502 is a volatile memory, and therefore, parameters of correction amounts obtained from the detection of a position error and the detection of phases of the photosensitive drums are stored in a non-volatile memory such as an EEPROM (Electrically Erasable Programmable Read Only Memory), and are expanded on the RAM 502.

FIG. 5 is a block diagram of a functional configuration of the printer part 300. The printer part 300 includes a printing control part 51, a direct transfer part 52, a primary transfer part 53, a secondary transfer part 54, a detection part 55 and a color adjustment part 56.

The printing control part 51 controls the entirety of the system of the printer part 300 for carrying out full-color printing, monochrome printing and so forth, and a color adjustment control process. The printing control part 51 may be realized by the CPU 501.

At a time of any one of full-color printing and monochrome printing, the direct transfer part 52 transfers, in a direct transfer method, a toner image of the color K for a printing image, which has been formed on the photosensitive drum 1K by the image forming unit 12K of the color K for the purpose of transferring to transfer paper P, to the transfer paper P that is conveyed by the transfer paper conveyance belt 8, at a place at which the photosensitive drum 1K and the driven roller 21K come into contact with each other via the transfer paper conveyance belt 8. Thus, printing the toner image of the color K on the transfer paper P is carried out.

Further, at a time of the color adjustment control process, the direct transfer part 52 moves the position adjustment patterns 13K as the color adjustment patterns or the phase detection patterns 14K as the color adjustment patterns that are toner ages of the color K formed on the photosensitive drum 1K onto the transfer paper conveyance belt 8. The direct transfer part 52 may be realized by the driven roller 21K.

At the time of the full-color printing under the control of the printing control part 51, the primary transfer part 53 superposes on each other toner images of the colors Y, M and C for printing images, having been formed on the respective photosensitive drums 1Y, 1M and 1C by the image forming units 12Y, 12M and 12C for the purpose of transferring to transfer paper P, on the intermediate transfer belt 6, in the indirect transfer method.

Further, at the time of the color adjustment control process, the primary transfer part 53 moves the position adjustment patterns 13Y, 13M and 13C as the color adjustment patterns or the phase detection patterns 14Y, 14M and 14C as the color adjustment patterns that are toner images of the colors Y, M and C formed on the respective photosensitive drums 1Y, 1M and 1C onto the intermediate transfer belt 6. The primary transfer part 53 may be realized by the primary transfer rollers 21Y, 21C and 21M.

At the time of the full-color printing, the transfer voltage is applied to the secondary transfer part 54 by the applying part (not shown), and thus, the secondary transfer part 54 transfers the toner images of the colors Y, M and C, which have been superposed on each other on the intermediate transfer belt 6 by the primary transfer part 53, to the transfer paper P that is conveyed by the transfer paper conveyance belt 8 to be superposed on the toner image of the color K. Thus, the toner images are printed on the transfer paper P.

Further, when detection of a position error is carried out at the time of the color adjustment control process, the voltage reverse to the transfer voltage applied at the time of printing is applied to the secondary transfer part 54 by the applying part (not shown), and thus, the secondary transfer part 54 transfers and moves the position adjustment patterns 13K having been formed on the transfer paper conveyance belt 8 onto the intermediate transfer belt 6. Further, when detection of phases of the photosensitive drums is carried out at the time of the color adjustment control process, the voltage reverse to the transfer voltage applied at the time of printing is applied to the secondary transfer part 54 by the applying part (not shown), and thus, the secondary transfer part 54 transfers and moves the phase detection patterns 14K having been formed on the transfer paper conveyance belt 8 onto the intermediate transfer belt 6. The secondary transfer part 54 may be realized by the secondary transfer roller 28.

When the detection of a position error is carried out at the time of the color adjustment control process, the detection part 55 detects the position adjustment patterns 13K having been moved onto the intermediate transfer belt 6 by the secondary transfer part 54 and the position adjustment patterns 131, 13M and 13C having been moved onto the intermediate transfer belt 6 by the primary transfer part 53. Further, when the detection of phases of the photosensitive drums is carried out at the time of the color adjustment control process, the detection part 55 detects the phase detection patterns 14K having been moved onto the intermediate transfer belt 6 by the secondary transfer part 54 and the phase detection patterns 14Y, 14M and 14C having been moved onto the intermediate transfer belt 6 by the primary transfer part 53. The detection part 55 may be realized by the pattern detection sensors 40.

The color adjustment part 56 carries out color adjustment (for correcting a color registration error) of respective images formed by the image forming units 12K, 12Y, 12M and 12C based on information of the position adjustment patterns 13K, 13Y, 13M and 13C as the color adjustment patterns and/or the phase detection patterns 14K, 14Y, 14M and 14C as the color adjustment patterns. The K color formed by the image forming unit 12K concerning the direct transfer method may be used as a reference color, and the color adjustment may be carried out for the colors C, M and Y formed by the image forming units 12C, 12M and 12Y concerning the indirect transfer method. However, the color adjustment is not limited to this way. Thus, it is possible to carry out the color adjustment for all the colors, i.e., for a printing image of the color K formed in the direct transfer method and printing images of the colors Y, M and C formed in the indirect transfer method. The color adjustment part 56 may be realized by the CPU 501.

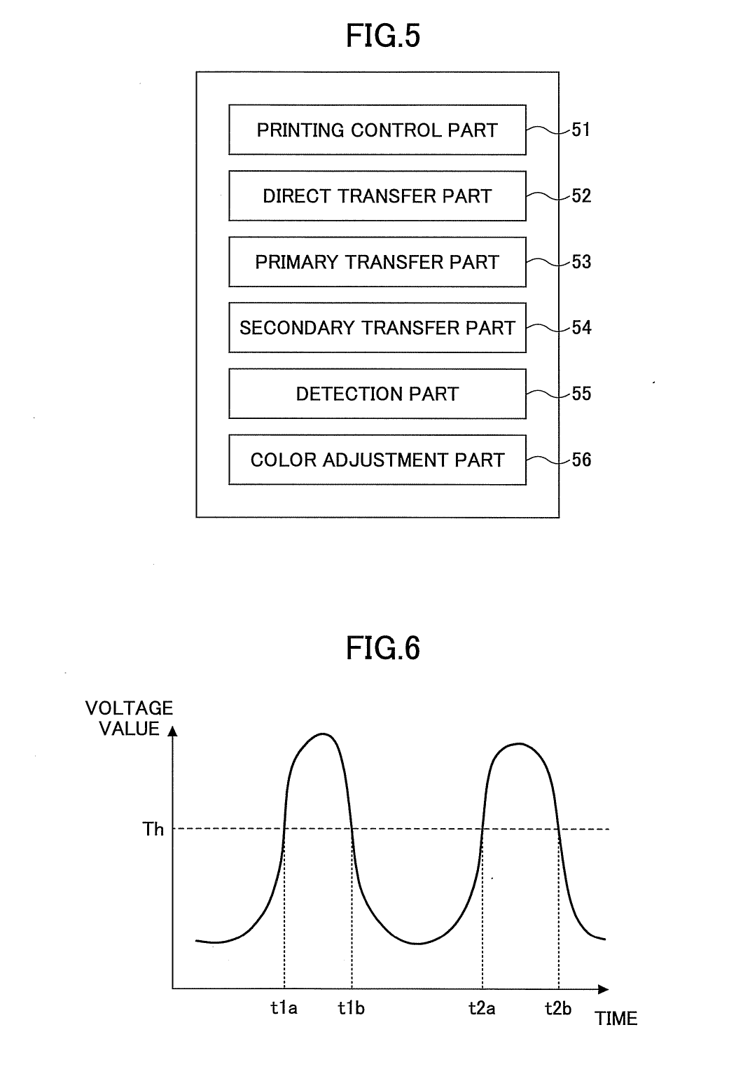

FIG. 6 shows a state of pattern detection carried out by using the pattern detection sensors 40. When the pattern exists directly below the pattern detection sensor 40, the output voltage value increases as shown in FIG. 6, and exceeds a threshold Th. Both the time points (t1a, t2a, . . . ) at which the threshold Th is exceeded and the time points (t1b, t2b, . . . ) at which the excess over the threshold Th is ended are sampled. Then, time points that are the respective centers between both ((t1a+t1b)/2, (t2a+t2b)/2, . . . ) are detected. Thus, the pattern (color adjustment pattern) is detected.

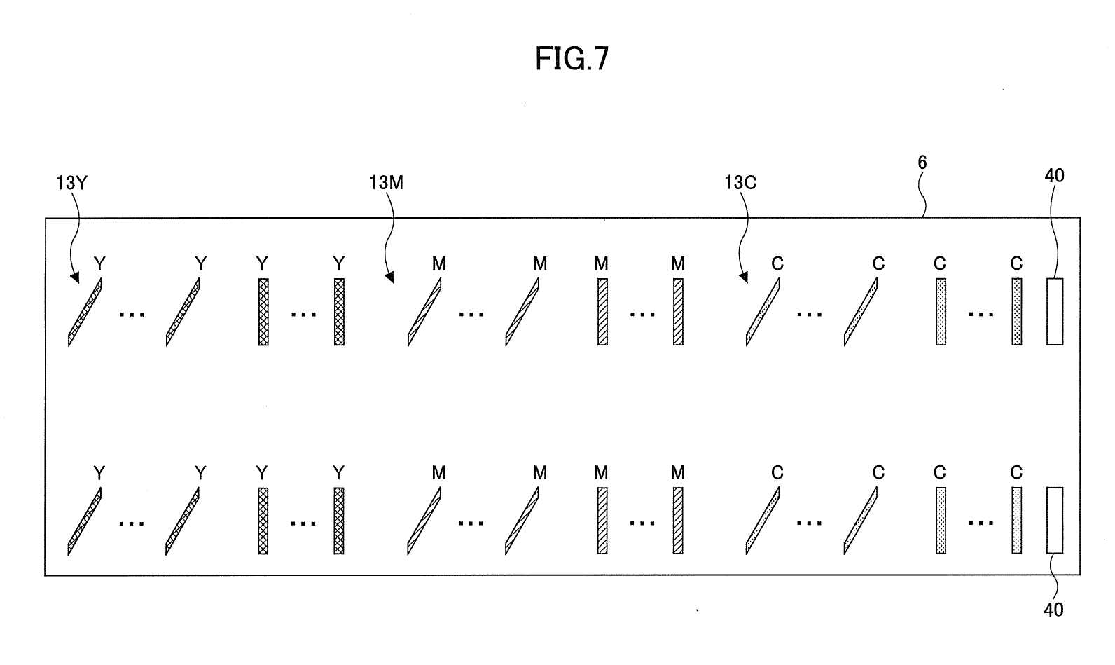

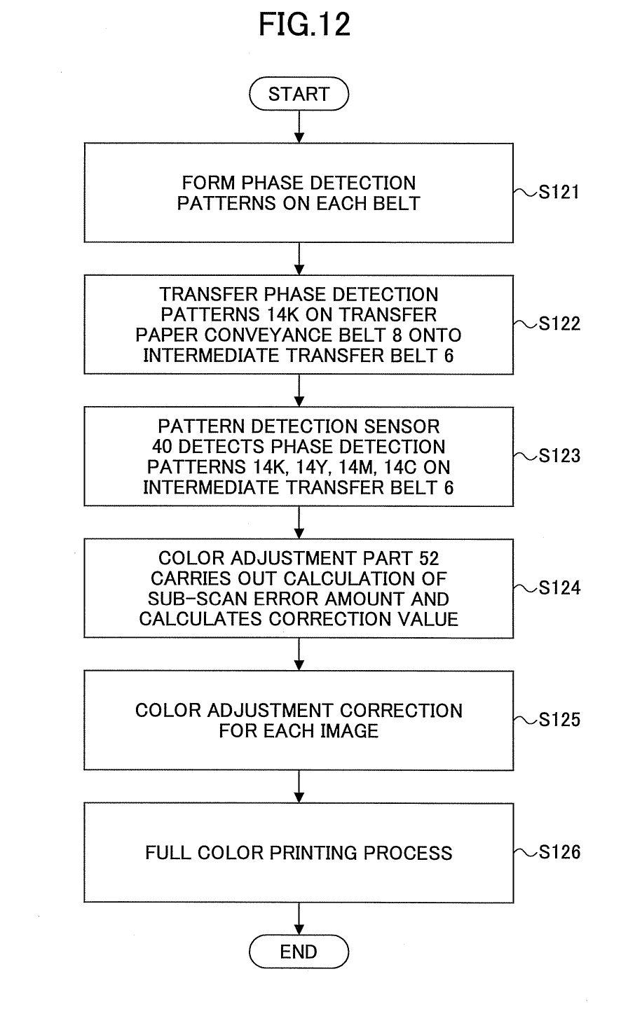

Below, with reference to FIGS. 7 through 10, a case will be described where at the time of the color adjustment control process, the detection of a position error is carried out by using the position adjustment patterns 13 (13K, 13Y, 13M and 130). After that, with reference to FIGS. 11 and 12, a case will be described where at the time of the color adjustment control process, the detection of phases of the photosensitive drums is carried out by using the phase detection patterns 14 (14K, 14Y, 14M and 14C).

First, with reference to FIGS. 7 through 10, the case will be described where at the time of the color adjustment control process, the detection of a position error is carried out by using the position adjustment patterns 13.

FIG. 7 shows a plan view showing one example of the position adjustment patterns 13Y, 13M and 13C as the color adjustment patterns which are moved onto the intermediate transfer belt 6 from the photosensitive drums 1Y, 1M and 10. As shown in FIG. 7, the position adjustment patterns 13Y, 13M and 13C as the color adjustment patterns are such that patterns of parallel (vertical) lines and patterns of oblique lines are arranged at fixed intervals in the sub-scan direction. The position adjustment patterns 13Y, 13M and 13C are formed repeatedly along the direction of conveyance of the intermediate transfer belt 6. In order to reduce an influence caused by an accidental error, the number of samples is increased, and thus, plural (two in the example of FIG. 7) sets of the position adjustment patterns 13Y, 13M and 13C are output, one of the plural sets corresponds to one of the two pattern detection sensors 40 and the other of the plural sets corresponds to the other of two pattern detection sensors 40, as shown in FIG. 7.

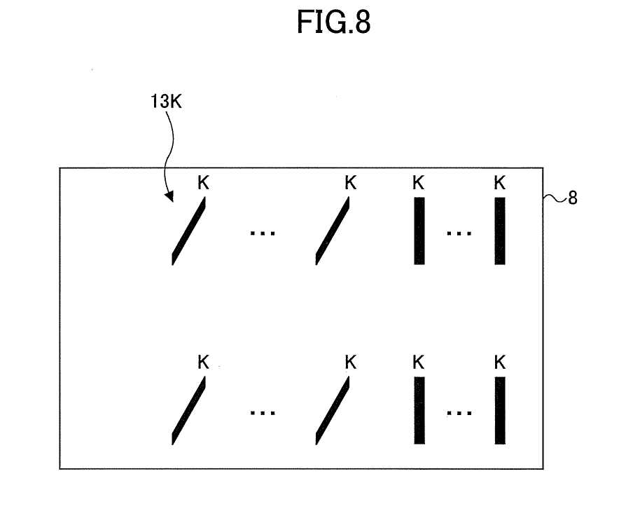

FIG. 8 shows a plan view showing one example of the position adjustment patterns 13K as the color adjustment patterns which are moved onto the transfer paper conveyance belt 8 from the photosensitive drum 1K. The position adjustment patterns 13K include patterns the same as those of the above-mentioned position adjustment patterns 13Y, 13M or 13C, and are formed repeatedly along the direction of conveyance of the transfer paper conveyance belt 8.

FIG. 9 shows a plan view of combination patterns. The combination patterns are completed as a result of, in a case where the detection of a position error is carried out at the time of the color adjustment control process, the secondary transfer roller 28 as the voltage reverse to the transfer voltage applied at the time of printing being applied to the secondary transfer part 54 by the applying part (not shown), and thus, the position adjustment patterns 13K that have been moved onto the transfer paper conveyance belt 8 being moved onto the intermediate transfer belt 6 onto which the position adjustment patterns 13Y, 13M and 13C have been moved. It is noted that the order of the moving of the position adjustment patterns 13K onto the intermediate transfer belt 6 and the moving of the position adjustment patterns 13Y, 13M and 13C onto the intermediate transfer belt 6 is such that any moving may be carried out first. That is, the moving of the position adjustment patterns 13Y, 13M and 13C onto the intermediate transfer belt 6 may be carried out earlier than the moving of the position adjustment patterns 13K onto the intermediate transfer belt 6. Further, the moving of the position adjustment patterns 13K onto the intermediate transfer belt 6 may be carried out earlier than the moving of the position adjustment patterns 13Y, 13M and 13C onto the intermediate transfer belt 6.

The pattern detection sensors 40 as the detection part 55 detect the position adjustment patterns 13K, 13Y, 13M and 13C from the combination patterns completed on the intermediate transfer belt 6 as described above. Further, the color adjustment part 56 calculates a main scan error amount (i.e., an amount of a position error in the main scan direction) and a sub-scan error amount (i.e., an amount of a position error in the sub-scan direction) by using the detected position adjustment patterns 13K, 13Y, 13M and 13C.

That is, the color adjustment part 56 calculates how much it is necessary to correct the position adjustment patterns 13Y, 13M and 13C with respect to the position adjustment patterns 13K that are used as reference patterns, according to the detection method described above with reference to FIG. 6. It is noted that in this method, the position adjustment patterns 13K are used as the reference patterns as mentioned above. However, it is merely one example, and position adjustment patterns of any color other than the color K may be used as reference patterns. Below, a specific method of calculating the correction amount will be described taking the position adjustment patterns 13C as an example. Also for the position adjustment patterns 13Y and 13M, the correction amounts can be calculated with the same method.

The color adjustment part 56 measures, for the position adjustment patterns 13K and 13C, a time period elapsed since a vertical line (in FIG. 9) of the position adjustment pattern is detected by the pattern detection sensor 40 until an oblique line of the position adjustment pattern formed to have the same color as that of the vertical line is detected, by means of a timer function of the CPU 501. Then, from the measured time period, the color adjustment part 56 calculates intervals ΔSk and ΔSc (see FIG. 9) between the vertical line and the oblique line. The color adjustment part 56 compares the calculated intervals ΔSk and ΔSc with respective reference values that are previously stored. Thus, the color adjustment part 56 calculates the amount of a position error in the main scan direction and the corresponding correction value.

Further, the color adjustment part 56 measures for the position adjustment patterns 13K and 13C, a time period elapsed since the position adjustment pattern 13K of the color K that is the reference color is detected by the pattern detection sensor 40 until the position adjustment pattern 13C of the color C is detected, by means of the timer function of the CPU 501. Then, from the measured time period, the color adjustment part 56 calculates an interval ΔFc (see FIG. 9) between the position adjustment patterns 13K and 13C. The color adjustment part 56 compares the calculated interval ΔFc with a reference value that is previously stored. Thus, the color adjustment part 56 calculates the amount of a position error in the sub-scan direction and the corresponding correction value.

The thus-calculated error amounts and correction values may be preferably recorded in the non-volatile memory such as an EEPROM. Thereby, it becomes not necessary to again output and detect the position adjustment patterns 13, by reading the correction amounts thus recorded in the non-volatile memory, even after the power supply has been turned off.

As a timing of the above-described detection of a position error by using the position adjustment patterns 13, for example, a time of initial setting of the color digital multifunction peripheral 100 or such may be used. Further, the above-mentioned detection of a position error may be carried out each time a predetermined number of sheets (depending on the configuration of the color digital multifunction peripheral 100, for example, every 50 through 200 sheets) are printed. This is because as a result of continued printing, expansion of the intermediate transfer belt 6 or the transfer paper conveyance belt 8 may occur because of a temperature rise occurring in the fixing apparatus 10, and thereby, a color registration error may occur. Therefore, when continuous printing is carried out, it becomes possible to obtain a proper printing result by carrying out the detection of a position error and the color adjustment process every certain number of sheets of printing.

Further, the detection of a position error may be carried out at any timing that is input from the operation part 400 or such and thus designated by a user or a service person. This is because a color registration error may occur because of replacement of the image forming units 12 or such, and it becomes possible to obtain a proper printing result without any color registration error as a result of a user designating any timing and the detection of a position error being carried out at any timing designated by the user.

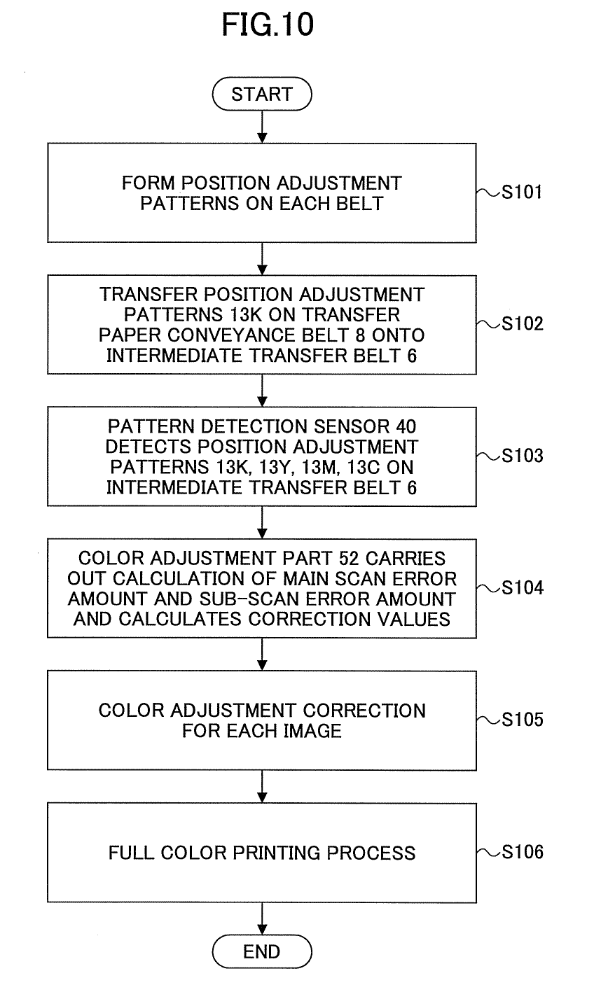

Below, with reference to FIG. 10, operations of a process of the detection of a position error by using the position adjustment patterns 13 at the time of the color adjustment control process will be described.

First, the position adjustment patterns 13 are moved onto the intermediate transfer belt 6 and the transfer paper conveyance belt 8, respectively (step S101).

That is, the driven roller 21K as the direct transfer part 52 moves the position adjustment patterns 13K as the color adjustment patterns which are toner images of the color K formed on the photosensitive drum 1K onto the transfer paper conveyance belt 8.

Further, the first transfer rollers 21Y, 21C and 21M as the first transfer part 53 move the position adjustment patterns 13Y, 13C and 13M as the color adjustment patterns, which are toner images of the colors Y, C and M formed on the respective photosensitive drums 1Y, 1C and 1M, onto the intermediate transfer belt 6.

Next, the voltage reverse to the transfer voltage applied at the time of printing is applied to the secondary roller 28 as the secondary transfer part 54 by the applying part (not shown), and thus, the secondary roller 28 transfers and moves the position adjustment patterns 13K having been formed on the transfer paper conveyance belt 8 onto the intermediate transfer belt 6 (step S102). It is noted that step S102 may be carried out prior to the process of moving the position adjustment patterns 13Y, 13M and 13C onto the intermediate transfer belt 6 by the primary transfer rollers 21Y, 21C and 21M as the primary transfer part 53 in step S101.

Next, the pattern detection sensors 40 as the detection part 55 detect the position adjustment patterns 13K, 13Y, 13M and 13C having been moved onto the intermediate transfer belt 6 (step S103).

Then, the color adjustment part 56 calculates the main scan error amount and the sub-scan error amount and calculates the corresponding correction values based on information of the position adjustment patterns 13K, 13Y, 13M and 13C thus detected by the pattern detection sensors 40 as the detection part 55 (step S104).

The color adjustment part 56 carries out correction for the color adjustment of respective printing images to be formed by the image forming units 12Y, 12M, 12C and 12K, based on the correction values calculated in step S104 (step S105). Specifically, adjustment of parameters of parts/components of the printer part 300 or such is carried out appropriately.

The printing control part 51 carries out the full-color printing process (step S106). That is, the driven roller 21K as the direct transfer part 52 transfers a printing image in a form of a toner image on the photosensitive drum 1K onto transfer paper P directly. The primary transfer rollers 21Y, 21C and 21M as the primary transfer part 53 superpose on each other printing images in a form of toner images on the photosensitive drums 1Y, 1M and 1C onto the intermediate transfer belt 6. The transfer voltage is applied to the secondary roller 28 as the secondary transfer part 54 by the applying part (not shown), and thus, the secondary roller 28 transfers the thus mutually superposed printing images of the colors Y, M and C onto the transfer paper P to further superpose the superposed printing images of the colors Y, M and C on the printing image of the color K. Thus, the full-color image is printed on the transfer paper P.

Next, with reference to FIGS. 11 and 12, a case will be described where at the time of the color adjustment process, the phase detection patterns 14 are used and phases of the photosensitive drums are detected. Basically, this case is the same as the above-described case of the detection of a position error using the position adjustment patterns 13, and duplicate description will be omitted.

FIG. 11 shows a plan view of combination patterns. The combination patterns are completed as a result of, in a case where the detection of phases of the photosensitive drums is carried out at the time of the color adjustment control process, the voltage reverse to the transfer voltage applied at the time of printing being applied to the secondary transfer roller 28 as the secondary transfer part 54 by the applying part (not shown), and thus, the phase detection patterns 14K that have been moved onto the transfer paper conveyance belt 8 being moved onto the intermediate transfer belt 6 onto which the phase detection patterns 14Y, 14M and 14C have been moved. FIG. 11 corresponds to FIG. 9 of the case where the detection of a position error is carried out by using the position adjustment patterns 13. It is noted that the order of the moving of the phase detection patterns 14K onto the intermediate transfer belt 6 and the moving of the phase detection patterns 14Y, 14M and 14C onto the intermediate transfer belt 6 is such that any moving may be carried out first. That is, the moving of the phase detection patterns 14Y, 14M and 14C onto the intermediate transfer belt 6 may be carried out earlier than the moving of the phase detection patterns 14K onto the intermediate transfer belt 6. Further, the moving of the phase detection patterns 14K onto the intermediate transfer belt 6 may be carried out earlier than the moving of the phase detection patterns 14Y, 14M and 14C onto the intermediate transfer belt 6.

The pattern detection sensors 40 as the detection part 55 detect the phase detection patterns 14K, 14Y, 14M and 14C from the combination patterns completed on the intermediate transfer belt 6 as described above. Further, the color adjustment part 56 calculates the sub-scan error amount by using the detected phase detection patterns 14K, 14Y, 14M and 14C.

The total lengths of each of the phase detection patterns 14M, 14C, 14K and 14Y along the direction along which the phase detection patterns 14M, 14C, 14K and 14Y are arranged in FIG. 11 correspond to one turn of the respective photosensitive drums 1K, 1Y, 1M and 10. Then, phase information of the photosensitive drums 1K, 1Y, 1M and 10 is detected. For example, the timer function of the CPU 501 is used to measure a timing at which the phase detection patterns 14C of the color C are detected and a timing at which the phase detection patterns 14M of the color M are detected, and thus, a position error in the sub-scan direction (sub-scan position error amount) and a corresponding correction value is detected. It is noted that since it is sufficient to eliminate any error in phases among the photosensitive drums, it is not necessary that the color K be used as a reference color.

The color adjustment part 56 then determines, from the detected sub-scan position error amount, by how much angular differences the photosensitive drums 1K, 1Y, 1M and 1C of the respective colors are rotated, and carries out correction to shift timings of starting up the photosensitive drums 1K, 1Y, 1M and 1C of the respective colors to correct the phase angles accordingly.

The thus-calculated error amount and/or correction value may preferably be recorded in the non-volatile memory such as an EEPROM. Thereby, it becomes unnecessary to again output and detect the phase detection patterns 14, by reading the correction amount thus stored in the non-volatile memory, even after the power supply has been turned off.

As a timing of the detection of phases of the photosensitive drums by using the phase detection patterns 14, for example, a time of initial setting of the color digital multifunction peripheral 100 or such may be used.

Further, the detection of phases of the photosensitive drums may be carried out at any timing that is input from the operation part 400 or such and thus designated by a user or a service person. This is because a color registration error may occur because of replacement of the image forming units 12 or such, and it becomes possible to obtain a proper printing result without any color registration error as a result of a user designating any timing and the detection of phases of the photosensitive drums and the color adjustment process being carried out at any timing designated by the user.

Below, with reference to FIG. 12, operations of a process of the detection of phases of the photosensitive drums by using the phase detection patterns 14 at the time of the color adjustment control process will be described.

First, the phase detection patterns 14 are moved onto the intermediate transfer belt 6 and the transfer paper conveyance belt 8, respectively (step S121).

That is, the driven roller 21K as the direct transfer part 52 moves the phase detection patterns 14K as the color adjustment patterns which are toner images of the color K formed on the photosensitive drum 1K onto the transfer paper conveyance belt 8.

Further, the first transfer rollers 21Y, 21C and 21M as the first transfer part 53 move the phase detection patterns 14Y, 14C and 14M as the color adjustment patterns which are toner images of the colors Y, C and M formed on the respective photosensitive drums 1Y, 1C and 1M onto the intermediate transfer belt 6.

Next, the voltage reverse to the transfer voltage applied at the time of printing is applied to the secondary roller 28 as the secondary transfer part 54 by the applying part (not shown), and thus, the secondary roller 28 transfers and moves the phase detection patterns 14K having been formed on the transfer paper conveyance belt 8 onto the intermediate transfer belt 6 (step S122). It is noted that step S122 may be carried out prior to the process of moving the phase detection patterns 14Y, 14M and 14C onto the intermediate transfer belt 6 by the primary transfer rollers 21Y, 21C and 21M as the primary transfer part 53 in step S121.

Next, the pattern detection sensors 40 as the detection part 55 detect the phase detection patterns 14K, 14Y, 14M and 14C having been moved onto the intermediate transfer belt 6 (step S123).

Then, the color adjustment part 56 calculates the sub-scan error amount and calculates the corresponding correction value based on information of the phase detection patterns 14K, 14Y, 14M and 14C thus detected by the pattern detection sensors 40 as the detection part 55 (step S124).

The color adjustment part 56 carries out correction for color adjustment of respective printing images to be formed by the image forming units 12Y, 12M, 12C and 12K based on the correction value calculated in step S124 (step S125). Specifically, such a correction is carried out that the timings of starting up the photosensitive drums 1K, 1Y, 1M and 1C of the respective colors are shifted appropriately.

The printing control part 51 carries out the full-color printing process (step S126). That is, the driven roller 21K as the direct transfer part 52 transfers a printing image in a form of a toner image developed from a latent image on the photosensitive drum 1K onto transfer paper P directly. The primary transfer rollers 21Y, 21C and 21M as the primary transfer part 53 superpose on each other printing images in a form of toner images developed from latent images on the photosensitive drums 1Y, 1M and 1C onto the intermediate transfer belt 6. The transfer voltage is applied to the secondary roller 28 as the secondary transfer part 54 by the applying part (not shown), and thus, the secondary roller 28 transfers the thus mutually superposed printing images of the colors Y, M and C onto the transfer paper P to further superpose the superposed printing images of the colors Y, M and C on the printing image of the color K. Thus, the full-color printing process is carried out.

Thus, according to the present embodiment, it is possible to detect the position adjustment patterns 13 and the phase detection patterns 14 as the color adjustment patterns only by means of the pattern detection sensors 40 as the detection part 55 provided for the intermediate transfer belt 6. Therefore, it is not necessary to provide the pattern detection sensors 40 as the detection part 55 for the transfer paper conveyance belt 8. Thereby, it is possible to avoid a problem otherwise occurring because of the apparatus configuration that if the pattern detection sensors 40 as the detection part 55 were provided for the transfer paper conveyance belt 8, the position above the transfer paper conveyance belt 8 would be close to the fixing apparatus 10 and the sensors 40 would be likely to be influenced by a temperature rise of the fixing apparatus 10; also the position would correspond to a unit part in which a door is opened and closed by the user for the purpose of removing jammed paper, and thus, trouble or malfunction of the sensors 40 would be likely to occur.

The present invention is not limited to the specifically disclosed embodiments, and variations and modifications may be made without departing from the scope of the present invention.

The present application is based on Japanese Priority Application No. 2010-062737 filed on Mar. 18, 2010, the entire contents of which are hereby incorporated herein by reference.

What is claimed is:

1. An image forming apparatus comprising:
a direct transfer part that moves color adjustment patterns of a single color having been formed on a photosensitive drum and that is used for color adjustment of respective printing images to a direct transfer member;
a secondary transfer part that moves the color adjustment patterns of the single color having been moved to the direct transfer member by the direct transfer part to an intermediate transfer member;
a primary transfer part that moves color adjustment patterns of plural colors having been formed on plural photopositive drums and that is used for the color adjustment of the respective printing images to the intermediate transfer member;
a detection part that detects the color adjustment patterns of the single color having been moved to the intermediate transfer member by the secondary transfer member and the color adjustment patterns of the plural colors having been moved to the intermediate transfer member by the primary transfer member; and
a color adjustment part that carries out the color adjustment of the respective printing images based on information of the color adjustment patterns of the single color and the color adjustment patterns of the plural colors detected by the detection part.

2. The image forming apparatus as claimed in claim 1, wherein
the direct transfer part transfers the printing image of the single color having been formed on the photosensitive drum to transfer paper that is conveyed by the direct transfer member,
the primary transfer part superposes the printing images of the plural colors having been formed on the plural photosensitive drums on each other on the intermediate transfer member,
the secondary transfer part transfers the printing images of the plural colors having been superposed on each other on the intermediate transfer member by the primary transfer part to the transfer paper that is conveyed by the direct transfer member,
the image forming apparatus carries out printing by transferring the printing image of the single color and the printing images of the plural colors on the transfer paper by using the direct transfer part and the secondary transfer part,
the detection part detects the color adjustment patterns of the single color and the plural colors used for the color adjustment of the respective printing images, and
the color adjustment part carries out the color adjustment of the respective printing images in a main scan direction and a sub-scan direction.

3. The image forming apparatus as claimed in claim 2, wherein:
the secondary transfer part transfers the printing images of the plural colors having been superposed on each other on the intermediate transfer member by the primary transfer part to the transfer paper that is conveyed by the direct transfer member, by having applied a transfer voltage, and
the secondary transfer part moves the color adjustment patterns of the single color having been moved to the direct transfer member by the direct transfer part to the intermediate transfer member, by having applied a voltage reverse to the transfer voltage.

4. The image forming apparatus as claimed in claim 1, wherein
the color adjustment patterns of the single color and the plural colors are position adjustment patterns used by the detection part to detect a position error of the respective printing images in a main scan direction and a sub-scan direction.

5. The image forming apparatus as claimed in claim 1, wherein
the color adjustment patterns of the single color and the plural colors are phase detection patterns used by the detection part to detect phases of the photosensitive drums of the single color and the plural colors.

6. The image forming apparatus as claimed in claim 4, wherein
the color adjustment part carries out the color adjustment of the respective printing images based on the information of the color adjustment patterns of the single color and the plural colors detected by the detection part each time a predetermined number of sheets are printed.

7. The image forming apparatus as claimed in claim 1, wherein
information of a correction amount for a position error obtained based on the information of the color adjustment patterns of the single color and the plural colors detected by the detection part is stored in a non-volatile memory.

8. The image forming apparatus as claimed in claim 1, wherein
an input by a user is received from an operation part, and the color adjustment of the respective printing images is carried out based on the information of the color adjustment patterns of the single color and the plural colors detected by the detection part at any timing designated by the user.
